(19) United States
(12) Patent Application Publication
(10) Pub. No.: US 2016/0282680 A1
(43) Pub. Date: Sep. 29, 2016

(54) LIQUID CRYSTAL PANELS

(71) Applicant: SHENZHEN CHINA STAR OPTOELECTRONICS TECHNOLOGY CO., LTD., Shenzhen, Guangdong (CN)

(72) Inventor: Sikun HAO, Shenzhen, Guangdong (CN)

(73) Assignee: Shenzhen China Star Optoelectronics Technology Co., Ltd., Shenzhen, Guangdong (CN)

(21) Appl. No.: 14/398,460

(22) PCT Filed: Sep. 25, 2014
(86) PCT No.: PCT/CN2014/087382

§ 371 Date: Nov. 1, 2014

(30) Foreign Application Priority Data
Sep. 18, 2014 (CN) 201410478304.9

(51) Int. Cl. G02F 1/1343; G02F 1/1335

(52) U.S. Cl. CPC G02F 1/134309; G02F 1/133514; G02F 2201/50; G02F 2201/123; G02F 2201/121

(57) ABSTRACT

A liquid crystal panel is disclosed. The liquid crystal panel includes a first substrate, a second substrate, and a liquid crystal layer between the first substrate and the second substrate. The first substrate includes a plurality of pixels respectively corresponding to one pixel electrode. The pixel electrode includes a plurality of primary electrodes and a plurality of branch electrodes extending from the primary electrodes. The second substrate includes a base substrate and a common electrode layer formed on the base substrate. The common electrode layer includes a plurality of recessed portions facing toward the base substrate, and each of the recessed portions faces toward one corresponding primary electrode of the pixel electrode. In this way, the liquid crystal efficiency of pixels is enhanced and an applicable range of ultra-high-resolution, small-sized panels of VA mode may be extended.

### BACKGROUND OF THE INVENTION

1. Field of the Invention

The present disclosure relates to liquid crystal display technology, and more particularly to a liquid crystal panel.

2. Discussion of the Related Art

Vertical alignment (VA) thin-film transistor liquid crystal devices (TFT-LCDs) are characterized by attributes including high aperture rate, high resolution, and wide viewing angles, and thus are widely adopted by large-scale LCDs. As shown in FIG. 1, pixel electrodes of TFT array substrate of conventional VA mode LCDs are designed as fish-bones. That is, the electrode is divided into a plurality of display areas by primary electrodes vertical to each other. Each display area is configured with stripe-like branch electrodes spaced apart from each other. Referring to FIG. 2, the electrodes of color filter (CF) substrates are film-shaped operating as common electrode. The common electrodes of the pixel electrodes of FIGS. 1 and 2 are combined together to form the liquid crystal panel. FIG. 3 shows the optical effect of the liquid crystal panel of FIGS. 1 and 2. It can be seen that two dark lines vertical to each other are shown in a central portion of the pixel for the reason that the liquid crystal alignment is parallel to a transmission axis or an absorption axis of polarizers. The width of the dark lines may be decreased by decreasing the width of the primary electrodes of the pixel electrodes of the TFT array substrate.

However, the width of the dark lines caused by the electrodes of the liquid crystal panel may still affect the liquid crystal efficiency such that it is not feasible for the small-sized, high resolution panels to adopt the liquid crystal panels.

### SUMMARY

The object of the invention is to provide a liquid crystal panel for enhancing liquid crystal efficiency of pixels and for extending applicable range of ultra-high-resolution, small-sized panels of VA mode.

In one aspect, a liquid crystal panel includes: a first substrate comprising a plurality of pixels, each of the pixels corresponds to one pixel electrode, the pixel electrode comprises a plurality of primary electrodes and a plurality of branch electrodes extending from the primary electrodes; a second substrate opposite to the first substrate, the second substrate comprises a base substrate and a common electrode layer formed on the base substrate; a liquid crystal layer between the first substrate and the second substrate; and wherein the common electrode layer comprises a plurality of recessed portions recessing toward the base substrate, each recessed portion faces toward one corresponding primary electrode of the pixel electrode, a shape of the recessed portion is substantially the same with the shape of the primary electrode, and a cross section of the recessed portion is a trapezium having a first side and a second side parallel to the common electrode layer, the first side of the trapezium comprises an opening, and a width of the opening is larger than the width of the second side.

Wherein the second substrate further comprises a color filter (CF) layer arranged between the base substrate and the common electrode layer, a plurality of grooves are formed correspondingly on a surface of the CF layer facing toward the common electrode layer, and the recessed portions of the common electrode layer are respectively formed within the grooves.

Wherein the second substrate further comprises a CF layer and a protection layer, the CF layer is formed between the base substrate and the protection layer, the protection layer is formed between the CF layer and the common electrode layer, the protection layer comprises a plurality of grooves formed corresponding on a surface of the protection layer facing toward the common electrode layer, and the recessed portions of the common electrode layer are respectively formed within the grooves.

In another aspect, a liquid crystal panel includes: a first substrate comprising a plurality of pixels, each of the pixels corresponds to one pixel electrode, the pixel electrode comprises a plurality of primary electrodes and a plurality of branch electrodes extending from the primary electrodes; a second substrate opposite to the first substrate, the second substrate comprises a base substrate, a CF layer arranged on the base substrate, and a common electrode layer formed on the CF layer; a liquid crystal layer between the first substrate and the second substrate; and wherein the second substrate comprises a plurality of grooves facing toward the base substrate, and each of the grooves faces toward one corresponding primary electrode of the pixel electrode.

Wherein the grooves are formed on a surface of the CF layer facing toward the common electrode layer, and the common electrode layer comprises a plurality of recessed portions respectively formed within the grooves of the CF layer.

Wherein the second substrate further comprises a protection layer between the CF layer and the common electrode layer, the grooves are formed on a surface of the protection layer facing toward the common electrode layer, and the common electrode layer comprises a plurality of recessed portions respectively formed within the grooves of the protection layer.

Wherein the shape of the groove is substantially the same with the shape of the primary electrode.

Wherein a cross section of the recessed portion is a trapezium having a first side and a second side parallel to the common electrode layer, the first side of the trapezium includes an opening, and a width of the opening is larger than the width of the second side.

In another aspect, a liquid crystal panel includes: a first substrate comprising a plurality of pixels, each of the pixels corresponds to one pixel electrode, the pixel electrode comprises a plurality of primary electrodes and a plurality of branch electrodes extending from the primary electrodes; a second substrate opposite to the first substrate, the second substrate comprises a base substrate and a common electrode layer formed on the base substrate; a liquid crystal layer between the first substrate and the second substrate; and wherein the common electrode layer comprises a plurality of recessed portions facing toward the base substrate, and each of the recessed portions faces toward one corresponding primary electrode of the pixel electrode.

Wherein the second substrate further comprises a color filter (CF) layer arranged between the base substrate and the common electrode layer, a plurality of grooves are formed correspondingly on a surface of the CF layer facing toward the common electrode layer, and the recessed portions of the common electrode layer are respectively formed within the grooves.

Wherein the second substrate further comprises a CF layer and a protection layer, the CF layer is formed between the base substrate and the protection layer, the protection layer is formed between the CF layer and the common electrode layer, the protection layer comprises a plurality of grooves are formed corresponding on a surface of the protection layer facing toward the common electrode layer, and the recessed portions of the common electrode layer are respectively formed within the grooves.

Wherein the shape of the groove is substantially the same with the shape of the primary electrode.

Wherein a cross section of the recessed portion is a trapezium having a first side and a second side parallel to the common electrode layer, the first side of the trapezium includes an opening, and a width of the opening is larger than the width of the second side.

In view of the above, the surface of the second substrate contacting with the liquid crystal panel has recessed portions formed thereon, and each of the recessed portions faces toward one corresponding primary electrode of the pixel electrode. An electrical field is formed at the recessed portions so as to enhance the alignment of the liquid crystal corresponding to the recessed portions. In this way, the width of the dark lines caused by the primary electrode is decreased so as to enhance the liquid crystal efficiency of the pixels of VA modes, and the applicable range of ultra-high-resolution, small-sized panels of VA mode is extended.

### BRIEF DESCRIPTION OF THE DRAWINGS

FIG. 1 is a schematic view of one conventional pixel electrode of TFT array substrate of liquid crystal panel.

FIG. 2 is a schematic view of one conventional common electrode of color filter (CF) array substrate of liquid crystal panel.

FIG. 3 is a schematic view showing the optical effects of the electrode of the liquid crystal panel of FIGS. 1 and 2.

FIG. 4 is a schematic view of the liquid crystal panel in accordance with one embodiment.

FIG. 5 is a schematic view of the liquid crystal panel in accordance with another embodiment.

FIG. 6 is a schematic view of the pixel electrode of the first substrate of the liquid crystal panel in accordance with one embodiment.

FIG. 7 is a schematic view of the common electrode layer of the second layer of the liquid crystal panel in accordance with one embodiment.

FIG. 8 is a schematic view of the common electrode layer of the liquid crystal panel in accordance with one embodiment.

FIG. 9 is a schematic view showing the optical effects of the recessed portion of the common electrode layer of one conventional liquid crystal panel.

FIG. 10 is a schematic view showing the optical effects of the liquid crystal panel in accordance with one embodiment.

FIG. 11 is a schematic view showing the relationship of the transmission rate of the locations indicated by a respective line in FIGS. 9 and 10.

FIG. 12 is a schematic view of the liquid crystal panel in accordance with another embodiment.

FIG. 13 is a schematic view of the structure of the CF layer of the liquid crystal panel of FIG. 12.

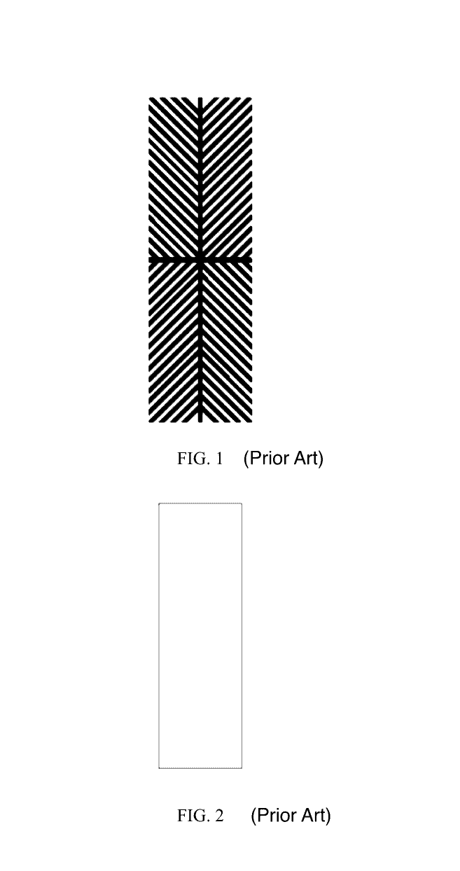

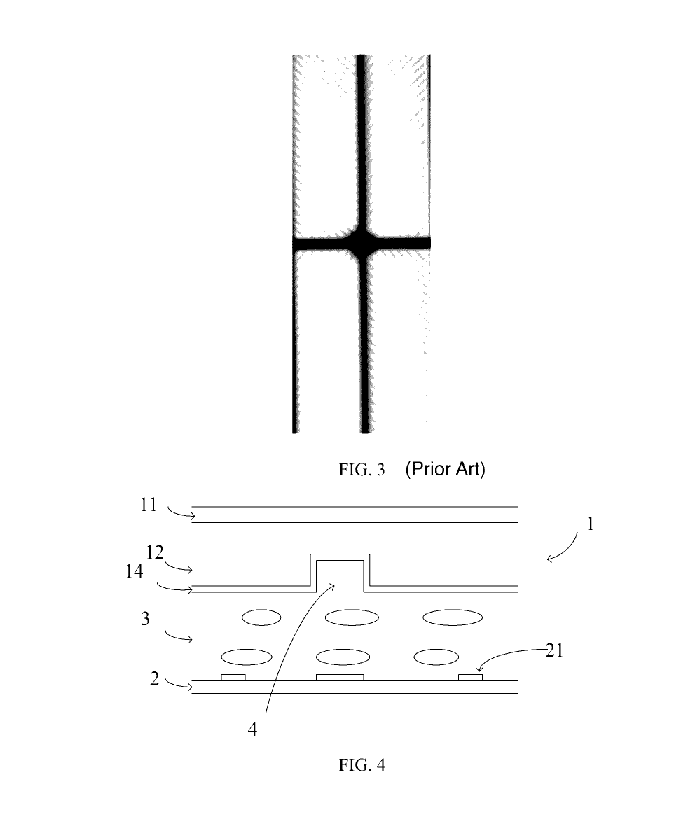

### DETAILED DESCRIPTION OF THE EMBODIMENTS

Embodiments of the invention will now be described more fully hereinafter with reference to the accompanying drawings, in which embodiments of the invention are shown.

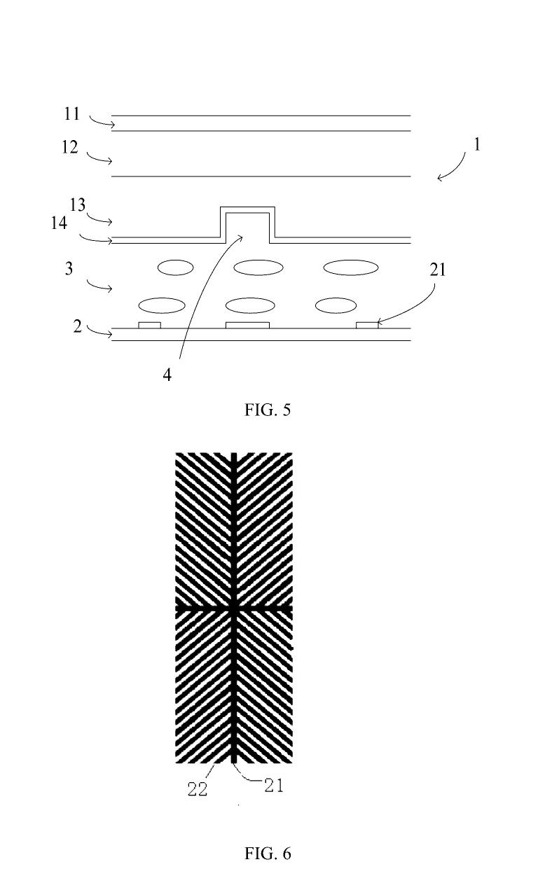

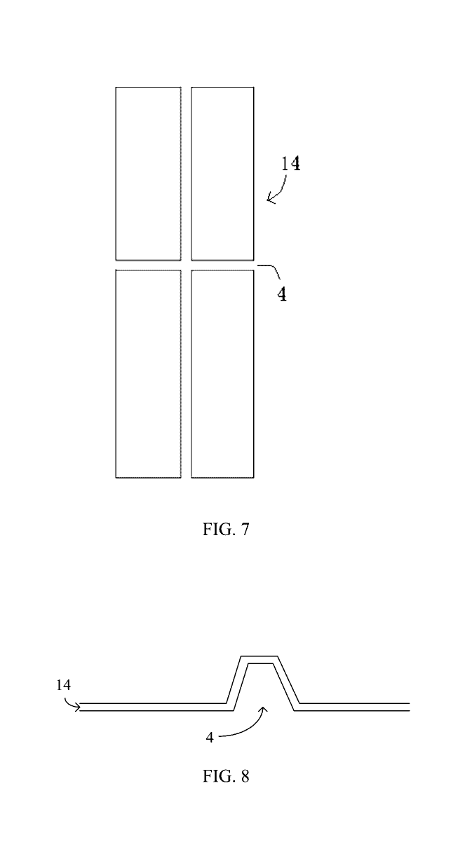

Referring to FIGS. 4 and 5, the liquid crystal panel includes a first substrate 2, a second substrate 1 arranged opposite to the first substrate 2, and a liquid crystal layer 3 between the second substrate 1 and the first substrate 2. As shown in FIG. 6, the first substrate 2 includes a plurality of pixels, and each of the pixel corresponds to one pixel electrode. The pixel electrode includes a plurality of primary electrodes 21 and a plurality of branch electrodes 22 extending from the primary electrodes 21. The primary electrode 21 divides the pixel into a plurality of areas. The branch electrodes 22 are arranged within the areas defined by the primary electrode 21. The primary electrode 21 may be two or more than two electrodes vertical to each other so as to define the pixel to four, six, or eight areas. Generally, the first substrate 2 includes a glass substrate with the pixel electrodes formed thereon. The second substrate 1 includes a base substrate 11 and a common electrode layer 14 formed on the base substrate 11. The base substrate 11 may be a transparent glass sheet. The common electrode layer 14 may be a transparent film electrode. As shown in FIG. 7, the common electrode layer 14 includes a plurality of portions 4 recessing toward the base substrate (“recessed portions 4”). Each recessed portions 4 faces toward one corresponding primary electrode 21 of the pixel electrode. The recessed portions 4 recess from the surface where the common electrode layer 14 contacts with the liquid crystal layer 3 toward the base substrate 11.

In one embodiment, a plurality of recessed portions are configured on the common electrode layer, and each recessed portions faces toward one corresponding primary electrode of the pixel electrode. The recessed portion forms an electrical field for enhancing the alignment of the liquid crystal corresponding to the recessed portions. In this way, the width of the dark lines caused by the primary electrode is decreased to enhance the liquid crystal efficiency of the pixels of VA modes, and the applicable range of ultra-high-resolution, small-sized panels of VA mode is extended.

In addition, as shown in FIG. 4, the second substrate 1 further includes a CF layer 12 formed between the base substrate 11 and the common electrode layer 14. The CF layer 12 is made by CF films. The CF layer 12 is formed above the base substrate 11. The common electrode layer 14 is deposed on the CF layer 12. A plurality of grooves are formed correspondingly on a surface of the CF layer 12 (not shown) facing toward the common electrode layer. The recessed portions 4 of the common electrode layer 14 are respectively formed within the corresponding grooves. In one embodiment, as the common electrode layer 14 is formed on the CF layer 12, the recessed portions 4 are formed in accordance with the grooves of the CF layer 12. The thickness of the common electrode layer 14 remains the same. The base substrate 11 and the common electrode layer 14 may be manufactured in a general way. The difference resides in that the grooves corresponding to the primary electrode 21 have to formed on the CF layer 12. By configuring such grooves, the common electrode layer 14 recesses toward the CF layer 12 without changing the thickness of the common electrode layer 14 so as to form the recessed portions 4. The electrical field formed within the recessed portions 4 may change the alignment of the liquid crystal corresponding to the primary electrode 21 to decrease the width of the dark lines caused by the primary electrode 21.

In another embodiment, as shown in FIG. 5, the second substrate 1 further includes a CF layer 12 and a protection layer 13. The CF layer 12 is formed between the base substrate 11 and the protection layer 13, and the protection layer 13 is formed between the CF layer 12 and the common electrode layer 14. The protection layer 13 is a coating layer formed on the CF layer 12 to smooth the CF layer 12 such that the quality are prevented from being deteriorated. The CF layer 12 is formed on the base substrate 11. The protection layer 13 is deposed on the CF layer 12. The common electrode layer 14 is deposed on the protection layer 13. The protection layer 13 includes a plurality of grooves arranged on a surface facing toward the common electrode layer 14 (not shown). The recessed portions 4 of the common electrode layer 14 are formed within corresponding grooves. In the embodiment, as the common electrode layer 14 is formed on the protection layer 13, the portions of the common electrode layer 14 corresponding to the grooves recess along with the grooves of the CF layer 12 so as to form the recessed portions 4. It can be understood that as the recessed portions 4 is formed in accordance with the grooves as a whole, the thickness of the common electrode layer 14 remains the same. The base substrate 11, the CF layer 12, and the common electrode layer 14 may be manufactured in a general way. However, the difference resides in that the portions of the protection layer 13 corresponding to the primary electrode 21 are formed as the grooves without changing the thickness of the common electrode layer. The common electrode layer 14 recesses toward the protection layer to form the recessed portions 4 corresponding to the primary electrode 21 on the common electrode layer 14. The recessed portions 4 forms the electrical field for changing the alignment of the liquid crystal corresponding to the primary electrode 21. As such, the width of the dark lines caused by the primary electrode 21 is decreased.

In one embodiment, the shape of the recessed portion 4 is substantially the same with that of the primary electrode 21. In an example, two or more than two recessed portions 4 that are vertical to each other may be formed on the common electrode layer 14 so as to divide the pixel into four, six, or eight areas. That is, the shape of the recessed portions 4 of the common electrode layer 14 are substantially the same with that of the primary electrodes 21, which results in the narrowest dark line.

As shown in FIG. 8, the cross section of the recessed portion 4 is a trapezium having a first side and a second side, the first side of the trapezium includes an opening, and the first side is arranged closer to the first substrate 2 than the second side. The second side of the recessed portion 4 is opposite to the opening, and the width of the second side is smaller than that of the opening. With such configuration, the CF layer material or protection layer may be retained at most while obtaining the best performance achieved by narrowing the dark lines. In other embodiments, the cross sections may be rectangular-shaped, arch-shaped, triangle-shaped, and so on.

In one embodiment, the second substrate may include a black matrix (BM) layer and a heat-isolation layer (not shown). The BM layer is arranged between the CF layer and the base substrate. Also, the BM layer may be manufactured in a general way.

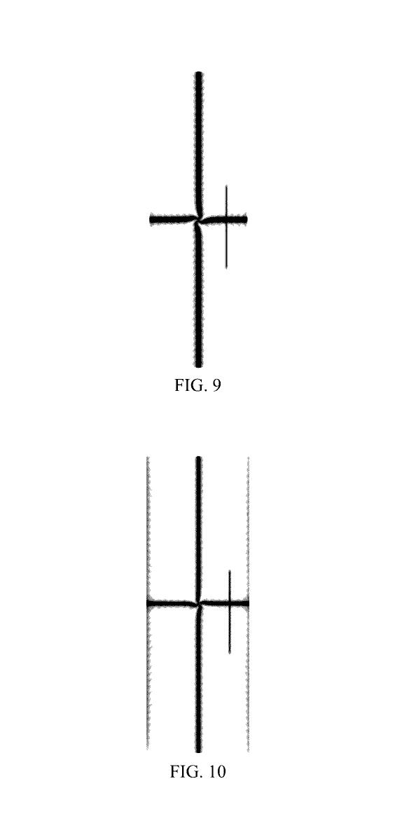

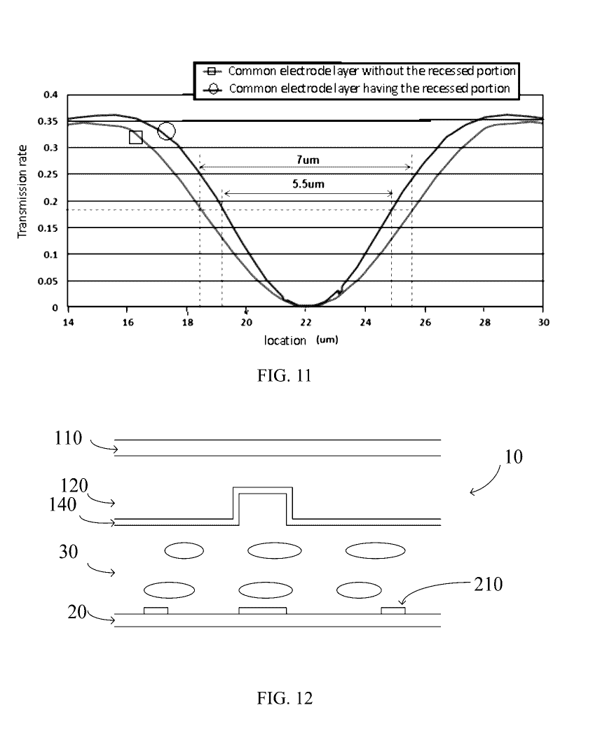

FIG. 9 is a schematic view showing the optical effects of the recessed portion of the common electrode layer 140 of one conventional liquid crystal panel. FIG. 10 is a schematic view showing the optical effects of the liquid crystal panel in accordance with one embodiment. FIG. 11 is a schematic view showing the relationship of the transmission rate of the locations indicated by a respective line in FIGS. 9 and 10, wherein the x-axis represents the location and the y-axis represents the transmission rate. In view of the FIGS. 9 and 10, it can be seen that by configuring the recessed portion 4 of the backlight driving control circuit 140 of the second substrate, the width of the dark line is decreased. Also referring to FIG. 11, the width of the dark line corresponding to the primary electrode 210 is decreased from conventional 7 microns to 5.5 micros. In addition, the transmission rate of the corresponding location is also enhanced.

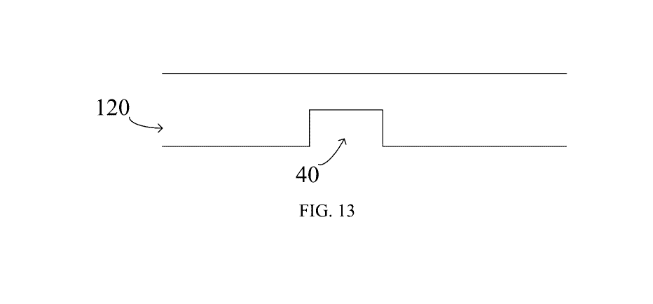

Referring to FIGS. 12 and 13, the liquid crystal panel, in another embodiment, includes a first substrate 20, a second substrate 10 opposite to the first substrate 20, and a liquid crystal layer 30 between the second substrate 10 and the first substrate 20. The first substrate 2 includes a plurality of pixels, and each of the pixel corresponds to one pixel electrode. The pixel electrode includes primary electrodes 210 and a plurality of branch electrodes 220 extending from the primary electrode 21. The primary electrode 210 divides the pixel into a plurality of areas. The branch electrodes 22 are arranged within the areas defined by the primary electrode 21. The primary electrode 21 may be two or more than two electrodes vertical to each other so as to define the pixel to four, six, or eight areas. The second substrate 10 includes a base substrate 110 and a common electrode layer 140 formed on the base substrate 110. The base substrate 110 may be a transparent glass sheet. The common electrode layer 140 may be a transparent film electrode. The second substrate 10 includes a plurality of portions 40 recessed toward the base substrate (“recessed portions 4”). Each recessed portions 4 faces toward one corresponding primary electrode 210 of the pixel electrode.

In one embodiment, a plurality of recessed portions toward the base substrate 110 are configured on the second substrate 10, and each recessed portions 40 faces toward one corresponding primary electrode 210 of the pixel electrode. One electrical field is formed between a side of the second substrate 10 being in a proximity of the liquid crystal and the corresponding grooves 40. The electrical field enhances the alignment of the liquid crystal corresponding to the recessed portions. In this way, the width of the dark lines caused by the primary electrode 210 is decreased to enhance the liquid crystal efficiency of the pixels of VA modes, and the applicable range of ultra-high-resolution, small-sized panels of VA mode is extended.

In addition, the recessed portion 40 is formed on one surface of the CF layer 120 facing toward the common electrode. The common electrode layer 140 includes a plurality of recessed portions formed within the grooves of the CF layer 120. In the embodiment, as the common electrode layer 140 is formed on the CF layer 120, the portions of the common electrode layer 140 corresponding to the grooves 40 recess toward the CF layer 120 to form the recessed portions. The recessed portion of the common electrode layer 140 recess in accordance with the grooves 40. The thickness of the common electrode layer 140 remains the same. The base substrate 110 and the common electrode layer 140 may be manufactured in a general way. The difference resides in that the portions of the CF layer 120 corresponding to the primary electrode 210 have to be formed as grooves. By configuring such grooves 40, the common electrode layer 140 recesses toward the CF layer 120 without changing the thickness of the common electrode layer 140 so as to form the recessed portions. The electrical field formed within the recessed portions may change the alignment of the liquid crystal corresponding to the primary electrode 210 to decrease the width of the dark lines caused by the primary electrode 210.

In one embodiment, the second substrate further includes a protection layer between the CF layer and the common electrode layer. The grooves are formed within the protection layer, and the grooves face toward the common electrode layer. The common electrode layer includes a plurality of recessed portions respectively corresponding to the grooves within the protection layer. As the common electrode layer is formed on the protection layer, the portions of the common electrode layer corresponding to the grooves recess toward the CF layer so as to form the recessed portions while the thickness of the common electrode layer remains the same. The base substrate, the CF layer, and the common electrode layer may be manufactured in a general way. The difference resides in that the grooves are formed on the protection layer in accordance with the primary electrode. By configuring the grooves on the protection layer without changing the thickness of the common electrode layer, the common electrode layer recesses toward the protection layer to form the recessed portions corresponding to the primary electrode on the common electrode layer. The recessed portion forms the electrical field for changing the alignment of the liquid crystal corresponding to the primary electrode. In this way, the width of the dark line corresponding to the primary electrode is decreased.

In one embodiment, the shape of the grooves is substantially the same with that of the primary electrode. In an example, two or more than two grooves that are vertical to each other may be formed on the second substrate so as to divide the corresponding pixel into four, six, or eight areas. That is, the shape of the grooves on the second substrate are substantially the same with that of the primary electrodes, which results in the narrowest dark line.

In one example, the cross section of the recessed portion is a trapezium having a first side and a second side parallel to the common electrode layer, the first side of the trapezium includes an opening, and a width of the opening is larger than the width of the second side.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal panel, comprising:
a first substrate comprising a plurality of pixels, each of the pixels corresponds to one pixel electrode, the pixel electrode comprises a plurality of primary electrodes and a plurality of branch electrodes extending from the primary electrodes;
a second substrate opposite to the first substrate, the second substrate comprises a base substrate and a common electrode layer formed on the base substrate;
a liquid crystal layer between the first substrate and the second substrate; and
wherein the common electrode layer comprises a plurality of recessed portions recessing toward the base substrate, each recessed portion faces toward one corresponding primary electrode of the pixel electrode, a shape of the recessed portion is substantially the same with the shape of the primary electrode, and a cross section of the recessed portion is a trapezium having a first side and a second side parallel to the common electrode layer, the first side of the trapezium comprises an opening, and a width of the opening is larger than the width of the second side.

2. The liquid crystal panel of claim of claim 1, wherein the second substrate further comprises a color filter (CF) layer arranged between the base substrate and the common electrode layer, a plurality of grooves are formed correspondingly on a surface of the CF layer facing toward the common electrode layer, and the recessed portions of the common electrode layer are respectively formed within the grooves.

3. The liquid crystal panel of claim of claim 1, wherein the second substrate further comprises a CF layer and a protection layer, the CF layer is formed between the base substrate and the protection layer, the protection layer is formed between the CF layer and the common electrode layer, the protection layer comprises a plurality of grooves formed corresponding on a surface of the protection layer facing toward the common electrode layer, and the recessed portions of the common electrode layer are respectively formed within the grooves.

4. A liquid crystal panel, comprising:
a first substrate comprising a plurality of pixels, each of the pixels corresponds to one pixel electrode, the pixel electrode comprises a plurality of primary electrodes and a plurality of branch electrodes extending from the primary electrodes;
a second substrate opposite to the first substrate, the second substrate comprises a base substrate, a CF layer arranged on the base substrate, and a common electrode layer formed on the CF layer;
a liquid crystal layer between the first substrate and the second substrate; and
wherein the second substrate comprises a plurality of grooves facing toward the base substrate, and each of the grooves faces toward one corresponding primary electrode of the pixel electrode.

5. The liquid crystal panel of claim of claim 4, wherein the grooves are formed on a surface of the CF layer facing toward the common electrode layer, and the common electrode layer comprises a plurality of recessed portions respectively formed within the grooves of the CF layer.

6. The liquid crystal panel of claim of claim 4, wherein the second substrate further comprises a protection layer between the CF layer and the common electrode layer, the grooves are formed on a surface of the protection layer facing toward the common electrode layer, and the common electrode layer comprises a plurality of recessed portions respectively formed within the grooves of the protection layer.

7. The liquid crystal panel of claim of claim 4, wherein the shape of the groove is substantially the same with the shape of the primary electrode.

8. The liquid crystal panel of claim of claim 4, wherein a cross section of the recessed portion is a trapezium having a first side and a second side parallel to the common electrode layer, the first size of the trapezium comprises an opening, and a width of the opening is larger than the width of the second side.

9. A liquid crystal panel, comprising:
a first substrate comprising a plurality of pixels, each of the pixels corresponds to one pixel electrode, the pixel electrode comprises a plurality of primary electrodes and a plurality of branch electrodes extending from the primary electrodes;
a second substrate opposite to the first substrate, the second substrate comprises a base substrate and a common electrode layer formed on the base substrate;
a liquid crystal layer between the first substrate and the second substrate; and
wherein the common electrode layer comprises a plurality of recessed portions facing toward the base substrate, and each of the recessed portions faces toward one corresponding primary electrode of the pixel electrode.

10. The liquid crystal panel of claim of claim 9, wherein the second substrate further comprises a color filter (CF) layer arranged between the base substrate and the common electrode layer, a plurality of grooves are formed correspondingly on a surface of the CF layer facing toward the common electrode layer, and the recessed portions of the common electrode layer are respectively formed within the grooves.

11. The liquid crystal panel of claim of claim 9, wherein the second substrate further comprises a CF layer and a protection layer, the CF layer is formed between the base substrate and the protection layer, the protection layer is formed between the CF layer and the common electrode layer, the protection layer comprises a plurality of grooves are formed corresponding on a surface of the protection layer facing toward the common electrode layer, and the recessed portions of the common electrode layer are respectively formed within the grooves.

12. The liquid crystal panel of claim of claim 9, wherein the shape of the groove is substantially the same with the shape of the primary electrode.

13. The liquid crystal panel of claim of claim 9, wherein a cross section of the recessed portion is a trapezium having a first side and a second side parallel to the common electrode layer, the first size of the trapezium comprises an opening, and a width of the opening is larger than the width of the second side.
